(19) United States
(12) Patent Application Publication
(10) Pub. No.: US 2026/0132038 A1
(43) Pub. Date: May 14, 2026

(54) Process for Removing Salts from an Aluminium Dross

(71) Applicant: FinexTech (Pty) Ltd, Cape Town (ZA)

(72) Inventor: Dennis Finch, Cape Town (ZA)

(21) Appl. No.: 19/387,935

(22) Filed: Nov. 13, 2025

(30) Foreign Application Priority Data
Nov. 14, 2024 (ZA) 2024/08657

(51) Int. Cl. C01C 1/242; C22B 21/06

(52) U.S. Cl. CPC C01C 1/242; C22B 21/062

(57) ABSTRACT

A process is described for the removal of salts from an aluminium dross. The process includes leaching particulate dross with a solvent to produce a brine solution and wetted dross, separating the wetted dross from the brine solution, hydrolysing the wetted dross to produce gas and a hydrolysed dross, reacting the gas with an acid, producing a salt solution, and removing liquid from the brine solution to produce a salt product.

### CROSS-REFERENCE TO RELATED APPLICATION

This application claims priority to South African Patent Application No. 2024/08657 filed November 14, 2024, the disclosure of which is hereby incorporated by reference in its entirety.

### BACKGROUND

### TECHNICAL FIELD

This disclosure relates to processing of aluminium dross to remove salts and other impurities.

### DESCRIPTION OF RELATED ART

A large portion of the total aluminium production is yielded from the recycling of an aluminium scrap feed, which is typically loaded in smelting furnaces. During the process, an oxide film tends to form on the aluminium feed, which can result in the loss of aluminium that can be recovered from the recycling process. A salt flux is used to combat this and has become commonplace in the smelting industry. The flux results in the disintegration of the oxide film and the prevention of further oxide formation by limiting the exposure of the aluminium feed with the reactive atmosphere. Most commonly, the salt flux comprises a mixture of sodium chloride (NaCl) and potassium chloride (KCl). All non-metallic compounds and components are absorbed by the liquid flux and an aluminium dross is formed that can be utilized to produce aluminium in a secondary production route.

The dross has a high aluminium content which makes it very suitable as a raw material for cement. The main components of such dross are Alumina (Al₂O₃), Spinel (MgAl₂O₄), Aluminium Nitride (AlN) and Aluminium metal (Al). The dross further contains some impurities, primarily Magnesia (MgO), Lime (CaO), Iron Oxide (Fe₂O₃), Silica (SiO₂) and salts. The salts in the dross are a combination of the salt flux components namely sodium chloride (NaCl) and potassium chloride (KCl).

The dross received from a secondary aluminium smelter typically contains around 12% - 20% salt. Cement producers can only accept very low concentrations of salt in any of the raw materials. The removal of salt from the aluminium dross is required before it may be sold to the cement industry. The other impurities are of lesser concern, although low concentrations of aluminium nitride and aluminium metal are preferred.

The process of aluminium recovery from the dross is often not economically viable and landfilling the aluminium dross has become a common occurrence. The dross is classified as toxic and hazardous waste, which has resulted in the landfilled dross leaching and releasing toxic, harmful, explosive, poisonous and odorous gases into the environment. Apart from the useful compounds it contains, there thus exists a further incentive to process or recycle it.

At present, many methods for removing salts from aluminium dross have not been found to be very effective. There is accordingly scope for improvement for aluminium dross to be effectively processed to remove the salts in an efficient manner with little to no waste, as an alternative to landfills.

The preceding discussion of the background is intended only to facilitate an understanding of the present disclosure. It should be appreciated that the discussion is not an acknowledgment or admission that any of the material referred to was part of the common general knowledge in the art as at the priority date of the application.

### SUMMARY

In accordance with an aspect of the disclosure there is provided a process for the removal of salts from an aluminium dross which includes the steps of:

leaching particulate dross with a solvent to produce a brine solution and wetted dross,

separating the wetted dross from the brine solution,

hydrolysing the wetted dross to produce gas and a hydrolysed dross,

reacting the gas with an acid, producing a salt solution, and

removing liquid from the brine solution to produce a salt product.

The process may include removing residual brine from the wetted dross before hydrolysing the wetted dross. Residual brine may be removed from the wetted dross by mixing water with the wetted dross in the one or more separators to produce a leaching solution. The particulate dross may be leached with the leaching solution.

The process may include removing fine dross particles from the brine solution before removing the liquid.

The wetted dross may be separated from the brine solution using one or more spiral washers.

The gas may be an ammonia gas. The acid may be sulphuric acid. The salt solution may be an ammonium sulphate solution.

The process may include separating fine dross particles from the brine solution in one or more filtration assemblies.

The process may include removing liquid from the brine solution by spray drying.

The process may include removing liquid from the brine solution by crystallisation.

The process may include maintaining the specific gravity of the brine solution at between 1.15 and 1.20.

The process may include maintaining the specific gravity of the brine solution at 1.18.

The salt product may be a mixture of sodium chloride and potassium chloride.

### BRIEF DESCRIPTION OF THE DRAWINGS

In the drawings:

FIG. 1 is a block flow diagram of an example embodiment of a process for the removal of salts from an aluminium dross;

FIG. 2 is a schematic flow diagram which illustrates an example of the washing and hydrolysis section of the process for removal of salts from an aluminium dross;

FIG. 3 is a schematic flow diagram which illustrates an example of the washing section of the process for removal of salts from an aluminium dross;

FIG. 4 is a schematic flow diagram which illustrates an example of the hydrolysis section of the process for removal of salts from an aluminium dross;

FIG. 5 is a schematic flow diagram which illustrates an example of the ammonia scrubbing section of the process for removal of salts from an aluminium dross;

FIG. 6 is a schematic flow diagram which illustrates an example of the filtration section of the process for removal of salts from an aluminium dross; and

FIG. 7 is a schematic flow diagram which illustrates an example of the drying section of the process for removal of salts from an aluminium dross.

### DETAILED DESCRIPTION

The purpose of the example process provided for removal of salts from an aluminium dross is to render the dross saleable as a raw material for cement production and other high alumina products. In the present embodiment, the byproducts produced may be processed into useful sellable products in order to minimise or eliminate waste.

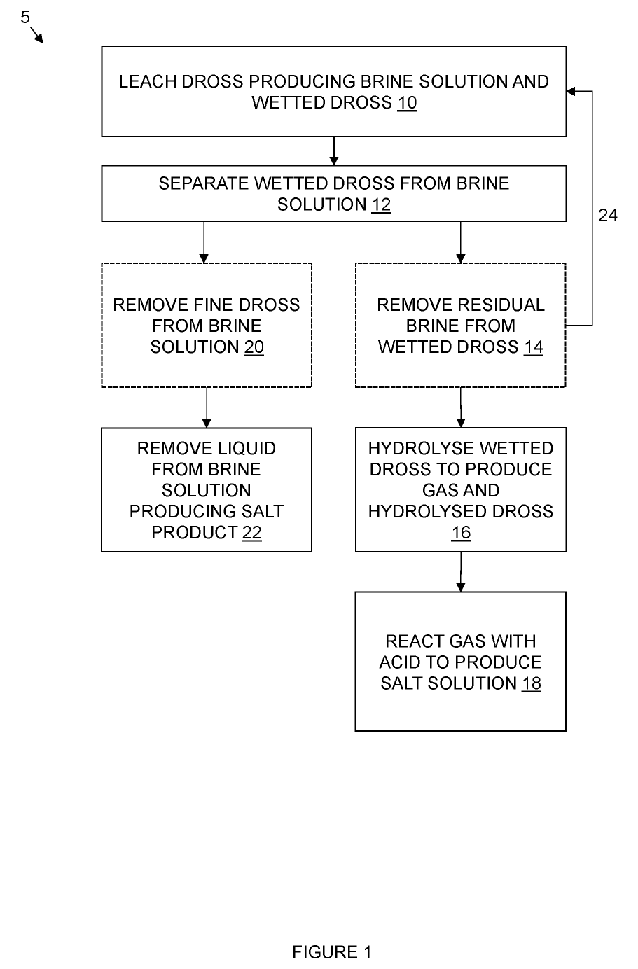

Referring to FIG. 1, a process for the removal of salts from an aluminium dross is provided and includes leaching (10) particulate dross with a solvent to produce a brine solution and wetted dross. The dross may be milled or crushed prior to leaching to have a particle size generally less than 6mm, preferably less than 4mm.

Leaching includes dissolving the salts from the particulate dross in the solvent thereby removing the salts from the particulate dross. The wetted dross may then be separated (12) from the brine solution. The separation may be done using spiral washers. The wetted dross may still contain residual brine solution not removed during this step and the residual brine may then be removed (14) from the wetted dross. Removing (14) the residual brine may be done by introducing a solvent, preferably water, into this step and bringing the solvent into contact with the wetted dross after the brine solution has been separated. The solvent which includes the removed residual brine may become a leaching solution and may be routed to the first step and used (24) as the leaching agent when leaching (10) the dross to produce a brine solution and a wetted dross.

The wetted dross may be hydrolysed (16) to produce a gas and a hydrolysed dross. The gas may be ammonia gas, and the aluminium in the dross may react to produce high alumina products. The ammonia gas may be reacted (18) with an acid to produce a salt solution which may be an ammonium sulphate solution.

Fine dross particles may be removed (20) from the brine solution. One or more filter assemblies may be used to achieve this step. The liquid may be removed (22) from the brine solution to produce a salt product. The liquid may be removed using spray drying. The salt product may contain a mixture of sodium chloride and potassium chloride.

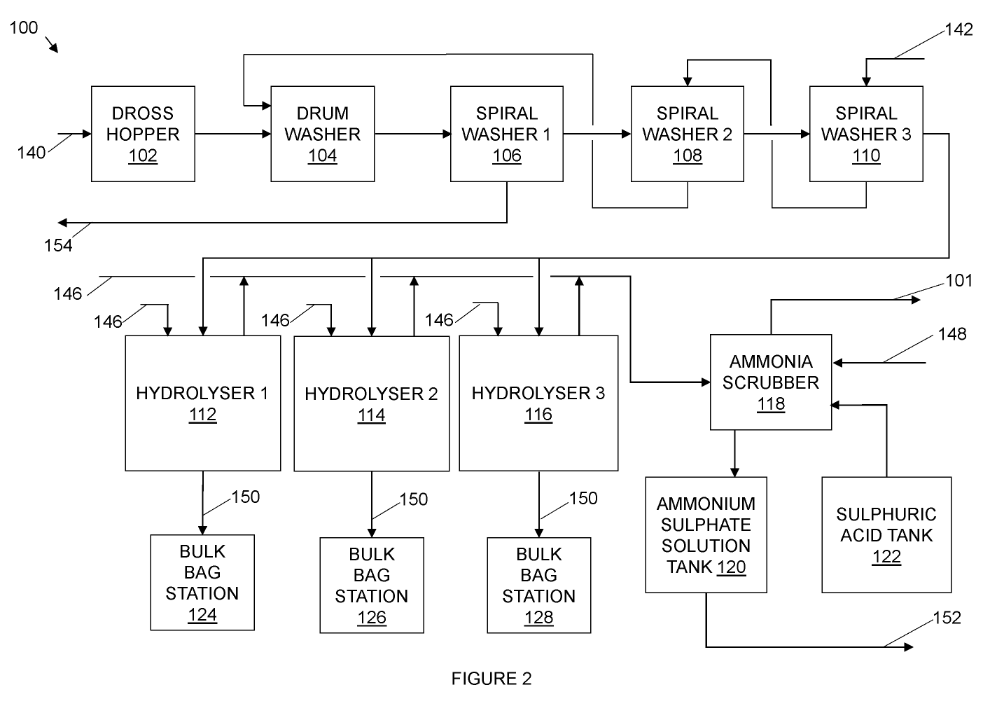

Referring to FIGS. 2 to 7, an example process for removal of salts from an aluminium dross includes a washing section (200), a hydrolysis section (300), a scrubbing section (400), a filtration section (500) and a drying section (600).

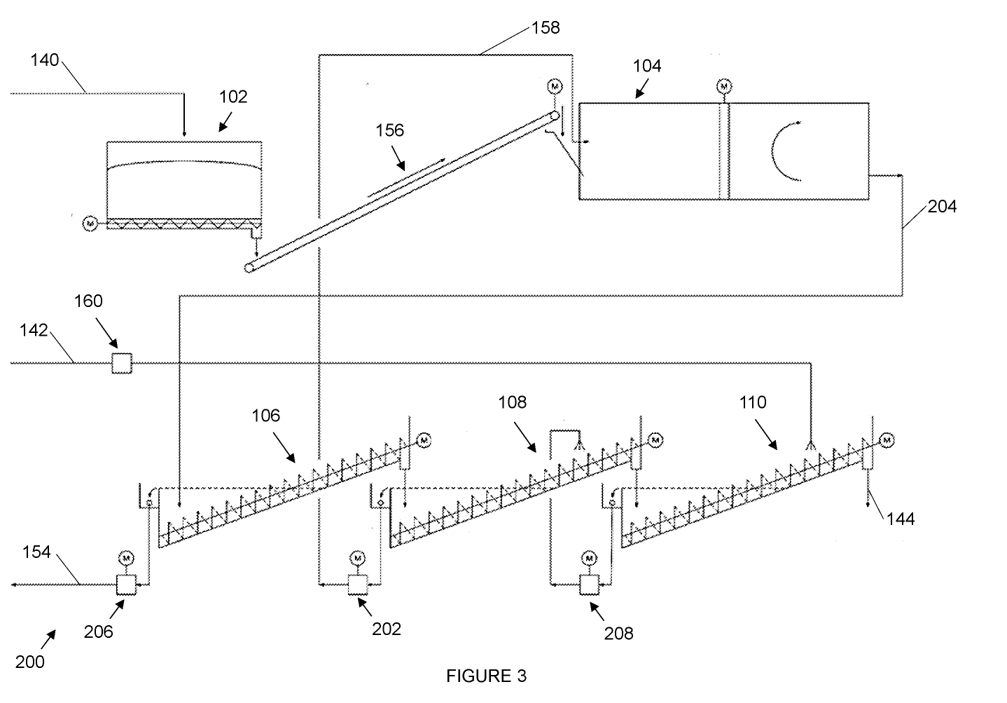

In the example illustrated in FIGS. 2 and 3, in the washing section, particulate aluminium dross (140) is fed into a dross storage hopper (102). The dross storage hopper (102) is used to store the aluminium dross (140) to be processed downstream. The dross storage hopper (102) may be filled by a front-end loader and may have a capacity of between 5000 kg and 7000 kg, in this embodiment around 6000 kg. The stored particulate aluminium dross (140) size in this embodiment is at least less than 6 mm, preferably equal or less than 4 mm with fines of down to 100 µm. The bottom of the dross storage hopper (102) base is fitted with a variable-pitch screw feeder driven by an electric motor of about 3 kW and is equipped with a variable speed drive (VSD). In the present embodiment, the rate-of-extraction from the dross storage hopper (102) is controlled using the motor VSD and the design extraction rate is between 2500 kg/h and 3750 kg/h.

A conveyor (156) is used to transfer the particulate aluminium dross from the dross storage hopper (102) to a drum washer (104) where it discharges particulate aluminium dross through a chute into the drum washer (104).

In this embodiment, the conveyor (156) is driven by an electric motor of about 3 kW equipped with a VSD in order to vary the conveyor speed.

In the drum washer (104) the particulate aluminium dross is washed by leaching the salt into solvent (158), preferably water or a recycled brine stream. In the present embodiment, the solvent (158) is a recycled stream routed from a second spiral washer (108), which is described below, and is pumped into the drum washer (104) by a transfer pump (202).

In this embodiment, the drum washer (104) has a 1.5 m in diameter and is about 8.0 m long. The drum washer (104) has internal flights and lifters which promote good solid/liquid contact. The particulate dross and solvent (158) are well mixed while being moved slowly from the inlet to the outlet. Operation is controlled to ensure that the particulate aluminium dross spends on average around 45 minutes inside the drum washer (104). By the time the material reaches the drum washer (104) outlet, the salt content of the particulate aluminium dross has been leached into the solvent (158) producing a brine solution with a specific gravity (SG) of between 1.15 and 1.20 preferably 1.18. The SG may correspond to the brine solution being about 90% saturated and thus fairly concentrated.

The drum washer (104) in this embodiment is driven by an electric motor of about 7.5 kW equipped with a VSD. The rotations per minute (rpm) of the drum washer (104) can be controlled between 1.0 and 1.5 using the motor VSD.

At the drum washer (104) outlet, the wetted dross and brine solution, in the form of a slurry (204), discharges into a solid/liquid separator assembly to effect separation of the wetted dross from the brine solution. In this embodiment, a series of three spiral washers (106, 108, 110) are used, each having an inclined trough with an internal spiral screw running in it, and an internal weir. In the present embodiment, each spiral screw is 0.7 m in diameter and 8 m long. Each spiral washer (106, 108, 110) is driven by an electric motor of about 5.5 kW which is equipped with a VSD. The rotational speed of the spiral screw may be controlled between 3 rpm and 5 rpm using the motor VSD.

The slurry (204) from the drum washer (104) discharges into the feed reservoir of the first spiral washer (106). Here, the coarse (heavier) dross particles settle to the bottom of the trough while the brine solution collects in the weir which it overflows at steady state. The finer (lighter) particles are typically entrained in the brine solution and also flow over the internal weir. The brine solution (154) containing fine dross particles which overflows the internal weir is extracted by a first transfer pump (206), in this embodiment a peristaltic (hose) pump which is a positive displacement pump and pumped to the brine holding tank (502) of the filtration section (500) of the process.

The nominal size of the first spiral washer discharge pump is 40 mm, and it is driven by a 1.5 kW electric motor equipped with a VSD. The pump discharge flowrate is controllable, using the motor VSD.

The spiral screw conveys the settled solids, being wetted dross and some of the brine solution, up the inclined trough and discharges into the second spiral washer (108).

The second spiral washer (108) and third spiral washer (110) serve as a two-stage counter current washing system. The purpose of these is to wash the wetted dross carried over from the first spiral washer (106) to remove residual brine solution. Solvent (142), in this embodiment, water, is added near the top of the third spiral washer (110), in this embodiment mid-way between the liquid level in the weir and the spiral screw discharge. It washes the wetted dross moving up the spiral as it flows down the chute where it collects and then overflows the internal weir and is pumped into the second spiral washer (108) near its top. Here it similarly washes the wetted dross moving up the spiral while it flows downwards into the weir. At steady state, the wash water, now a weak brine solution, overflows from the weir of the second spiral washer (108) and is pumped as the solvent for the leaching process into the drum washer (104). As the wash water cascades through the two-stage counter current washing system, it contacts dross and brine from a previous stage and leaches residual salt from the wetted brine. In so doing, its brine concentration increases.

The continuous spray of wash water in the second and third spiral washers (108, 110) displaces higher concentration brine which is extracted by the spiral screw along with the coarse dross. The displacement of higher concentration brine by the wash water reduces the salt content of the dross and brine mixture and provides the “washing” that is referred to.

As with the first spiral washer (106) the heavier dross particles fed into the second and third spiral washers (108, 110) settle to the bottom of the trough and are extracted by the spiral screw.

Fresh water which is of potable quality is used as the solvent (142) in this embodiment and it may be supplied from a pressurised source. It will be appreciated the wash water, or solvent (142), becomes more saturated with brine as it progresses through the process.

In this embodiment, a magnetic flowmeter (160) measures the solvent (142) flowrate into spiral washer 3 (110). The solvent (142) or wash water flowrate setting is controlled to be dependent on the feed rate and the salt content of the particulate aluminium dross (140) as well as the amount of liquid in the wetted dross leaving the third spiral washer (110). The preferable solvent (142) flow rate setting produces a solution exiting the drum washer (104) having an SG of between 1.15 and 1.20, preferably about 1.18. Excess solvent (142) may produce a solution with less dissolved salts (weaker brine) than required in the process and additional fuel for evaporation will be required at the dryer section (600) which is described below.

Lower volumes of solvent (142) than required will produce a saturated solvent which will result in salts remaining in the wetted dross exiting the third spiral washer (110), as there is not enough solvent to dissolve all the residual salts. Depending on the feed rate and salt content of the particulate aluminium dross (140), the flowrate of water (142) into the process should be between 2000 l/h and 3500 l/h.

Process control of the washing section (200) is, in this embodiment, manual. There are two feed streams to the washing section (200) namely wetted dross (140) containing particulate aluminium and the solvent (142). The volume of solvent (142) that is added to the process may be determined by the particulate aluminium dross (140) feed rate (mass per hour), salt concentration (wt%) in the particulate aluminium dross, the target brine solution SG (between 1.15 and 1.20, preferably at 1.18) and the volume of liquid exiting spiral washer 3 (110) with the wetted dross. All the added solvent may leave the washing section (200) in either the brine solution (154) to the filtration section (500) or with the wetted dross (144). The amount of particulate aluminium dross (140) fed to the plant is controlled by adjusting the speed of the VSD on the dross hopper (102) feeder motor. The volume of solvent (142) fed into the wash section (200) is controlled by adjusting a valve immediately downstream of the magnetic flowmeter (160). The flowrate is set at a value which gives the brine solution an SG of between 1.15 and 1.20, preferably 1.18. Regular measurement of the brine solution SG by hydrometer and logging is conducted. The liquid level in each overflow chamber of the spiral washes (106, 108, 110) should be checked regularly and the pump speeds adjusted accordingly.

The present embodiment may follow the following start-up procedure. To calibrate the dross hopper (102), a screw feeder test is conducted where the screw feeder is operated at 20 Hz (40% speed) and 40 Hz (80% speed). The dross hopper (102) is filled and the screw is completely covered along its length. A bucket and stopwatch method may be used to determine the feed rate in mass per hour for both tests. The Hz setting may then be determined to give the required feed rate using linear interpolation.

The spiral washers (106, 108, 110) are initially washed to ensure loose metals or rust that may potentially damage the pumps are removed from the system. A leak test may be conducted afterwards. The drum washer (104) and the spiral washers (106, 108, 110) may be filled with water. Any leaks observed may be rectified. Water may be pumped (208) from the third spiral washer (110) into the second spiral washer (108) for a number of minutes and any leaks observed may be rectified. A similar leak test may be conducted between the second spiral washer (108) and the drum washer (104) and between the drum washer (104) and the first spiral washer (106). A test may be conducted to ensure the solvent sprays into the second and third spiral washers (108, 110) work efficiently.

To commission the process, water may be recycled (202) from the first spiral washer (106) into the drum washer (104). All other pumps may be decommissioned. A pump speed of between 50% and 60%, preferably 55% (28 Hz) is used. The system is then allowed to stabilise. The pump speed may be increased if the level in the first spiral washer (106) decreases.

Particulate aluminium dross (140) is fed from the dross hopper (102) after all the checks above have been completed. The dross conveyor (156) is started to provide around 2500 kg/h of particulate aluminium dross (140) to the drum washer (104). All the spiral washers (106, 108, 110) screws should be running but the pumps (202, 208) on the second and third spiral washers (108, 110) should not be running. The system is maintained on this recycle step until the SG of the brine solution approached between 1.15 and 1.20, preferably 1.18. During this period dross and some water will be passing through the spiral washers (106, 108, 110) and discharged from the third spiral washer (110). Water may be added to the spiral washers (106, 108, 110) if needed during this period. When the SG of the brine solution (154) approaches between 1.15 and 1.20, preferably 1.18, recycling to the drum washer (104) is stopped and the wetted dross routed to the filtration section (500). The volume rate of solvent (142) introduced into the third spiral washer (110) is controlled at about 2300 l/h. The remaining two pumps on the spiral washers are then commissioned and the pump speed adjusted to pump the outflow from each spiral washer (106, 108, 110). The pump speed may need to be optimised in order to maintain the volume inflow and outflow of the spiral washers (106, 108, 110).

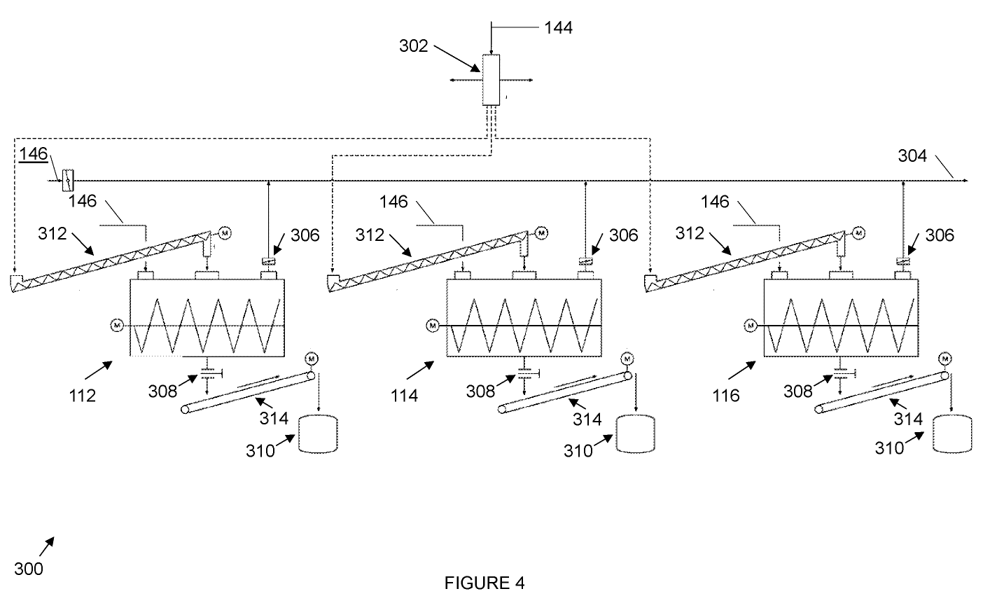

Referring to FIG. 4, the wetted dross (144) is routed to the hydrolysis section (300) of the process. In this embodiment, three parallel hydrolysers are used and the wetted dross is routed from the spiral washer 3 (110) to one of the hydrolysers (112, 114, 116) configured in parallel by an adjustable chute (302). The wetted dross (144) is routed to the hydrolysers (112, 114, 116) by transfer screws (312) which form inclined feeder units. Routing into the hydrolysers (112, 114, 116) is done through a 500 mm port, centrally located on the roof of the hydrolysers (112, 114, 116). The transfer screws (312) are driven by electric motors of about 0.55 kW which are equipped with VSD’s configured to vary the transfer screw’s speed. The hydrolysers (112, 114, 116) are ribbon blenders with a capacity of around 3000 kg each. These function to provide efficient mixing of the wetted dross and so allow the hydrolysis reactions to occur rapidly. Mixing is provided by the ribbons which are driven by electric motors of around 45 kW equipped with VSD’s capable of varying the speed of the ribbons.

The wetted (144) dross is transferred into the hydrolysers (112, 114, 116) where it is mixed with hot, hydrolysed dross remaining from the previous batch. This raises the temperature of the fresh wetted dross and allows hydrolysis to be rapidly initiated. During hydrolysis, ammonia gas (304) and very small quantities of hydrogen gas are released. These gases are mixed with dilution air (146) and are continuously extracted and routed to the ammonia scrubber section (400).

In this embodiment, each hydrolyser (112, 114, 116) has four roof ports which include two dilution air inlet ports, one wetted dross inlet port and one gas extraction port. The ducting from the gas extraction ports is fitted with butterfly valves (306) to allow control of the gas flow through the hydrolyser vessels and for isolation. Hydrolysis takes several hours to reach completion, after which between 40% and 60%, preferably 50% of the hydrolysed dross is discharged through valves (308) in the bottom of the hydrolyser vessels (112, 114, 116). The discharge rate of dross is manually controlled using the discharge valves (308).

Hydrolysed dross conveyors (314) transfer the hydrolysed dross from the hydrolysers (112, 114, 116) to bulk bag filling stations (310). The hydrolysed dross conveyors (314) may be inclined belt conveyors driven by electric motors of about 2.2 kW, equipped with VSD’s capable of varying the motor speeds. The hydrolysed dross conveyors feed the hydrolysed dross directly into bulk bags.

The washing section (200) of the process is a continuous process, while the hydrolysis section (300) of the process is a batch process. To ensure continuous operation of the process during hydrolysis, the wetted dross from the washing section is used to sequentially fill the hydrolysers such that one is being filled, while a second is in the process of hydrolysis and the third is finishing with hydrolysis and being discharged. Each of the separate hydrolyser vessels has its own hydrolyser transfer screw (312), hydrolysed dross conveyor (314) and bulk bag filling station (310).

The hydrolysed dross produced may be sold as a raw material in the cement industry and other high alumina products.

The gases (ammonia, hydrogen and air) (304) extracted from each hydrolyser are combined and mixed with additional dilution air (146) before entering the ammonia scrubber section (400).

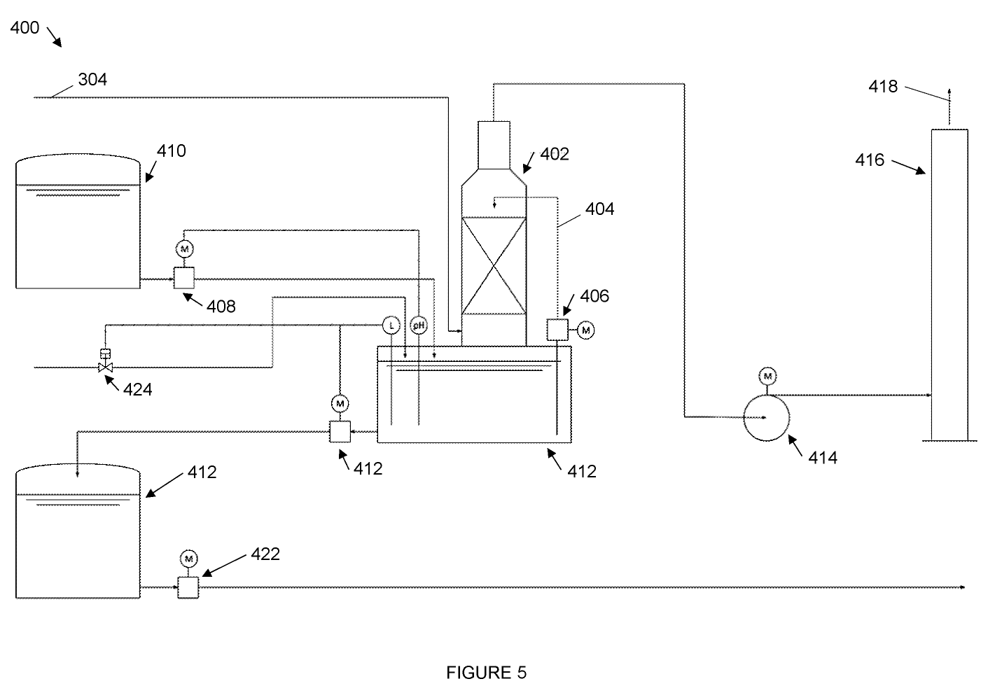

Referring to FIG. 5, the ammonia scrubber section (400) includes, in this embodiment, an absorption column (402) where the ammonia gas (304) from the dross hydrolysis section (300) is absorbed by a sulphuric acid stream (404) recirculated from a liquid reservoir (412), to produce an ammonium sulphate solution. The absorption column is mounted on top of the liquid reservoir (412). The absorption column is 1.0 m in diameter and the packed height is 2.5 m. The liquid reservoir (412) capacity is 1500 litres. The absorption column contains mass transfer packing which promotes contact between the rising gas stream and the descending liquid stream. The reservoir vessel (412) is fitted with pH and level transmitters to allow partial automated control of the system. As part of the ammonia scrubbing, a number of pumps (406) continually pump liquid from the liquid reservoir (412) to the top of the packed section of the column. Liquid flows down through the packing, and back into the reservoir. As liquid flows through the packing the pH increases due to absorption of ammonia. The pump circulating the liquid is driven by an electric motor of 2.2 kW.

A pump (408) pumps sulphuric acid from a storage tank (410) into the liquid reservoir (412) to reduce the liquid pH. The material of construction for the pump may be Polyvinylidene Fluoride (PVDF). Its operation is pH controlled. The sulphuric acid is pumped when the reservoir pH increases to around 6 and stops again when the pH decreased to around 3. The pump (408) is driven by a 0.75 kW electric motor.

A pump (422) pumps ammonium sulphate solution from the liquid reservoir (412) to the ammonium sulphate storage tank. The blowdown is initiated manually when the ammonium sulphate solution SG reaches a value of around 1.22. The pump is stopped automatically when the reservoir (412) level drops to around 30%. The pump (422) is driven by a 0.75 kW electric motor.

An induced draft (ID) (414) fan downstream of the column (402), or scrubber, extracts gases from the hydrolyser vessels (112, 114, 116) along with additional dilution air. The gases are drawn through the column (402), pass through the ID fan (414) and are then discharged to atmosphere (418) via the stack (416). The ID fan (414) material of construction is polypropylene in this embodiment and it has a capacity of 6000 m₃/h. The ID fan (414) is driven by an electric motor of 11 kW. The stack height is 3 m.

Also in this embodiment, the sulphuric acid tank (410) has a capacity of 20 m³ and is located within its own bunded area. The sulphuric acid used may be a spent acid having a concentration as low as around 75%, typically 78%. Industrial grade acid (around 98.5%) may also be used. Sulphuric acid may be extracted by the acid dosing pump (408) and pumped into the liquid reservoir (412) under pH control.

The ammonium sulphate storage tank (420) has a capacity of 20 m³ and is also located within its own bunded area. The ammonia sulphate tank (420) provides an intermediate storage and receives between 30% and 50%, preferably 40% ammonium sulphate solution blown down from the liquid reservoir (412). The ammonium sulphate solution is pumped (422) to final storage at a tank farm, as required. An ammonium sulphate transfer pump (422) transfers the ammonium sulphate solution from intermediate storage to final storage at the tank farm. The transfer may be initiated and stopped manually. The pump is driven by an electric motor of 1.5 kW.

The ammonium sulphate solution produced may be sold as fertiliser.

When commissioning, the liquid reservoir (412) is filled to a level between 40% and 60%, preferably 50%. This is done with water and the water is recirculated over the absorption column (402). As ammonia passes through the absorption column (402), the pH of the recirculation liquid may increase. Sulphuric acid is dosed into the liquid reservoir (412) intended to neutralise the rising pH and forms an ammonium sulphate solution. The sulphuric acid dosing may be automated and is based on ON/OFF control. When the pH in the liquid reservoir (412) increases to a value of around 6, the sulphuric acid dosing pump (408) starts and doses acid into the liquid reservoir. As acid is dosed, the pH drops. When the pH in the reservoir drops to around 3, the dosing pump (408) may stop. As this process repeats and ammonium sulphate is continuously formed, and the SG of the recirculating solution continues to increase. The target SG for a 40% ammonium sulphate solution is 1.22. The SG of the recirculating solution is regularly checked using a hydrometer and when an SG of around 1.22 is reached, the operator manually initiates a blowdown (426). The make-up water valve (424) is opened afterwards to fill the reservoir to around 50% level and then closed. This operating cycle may repeat until the system is shut down.

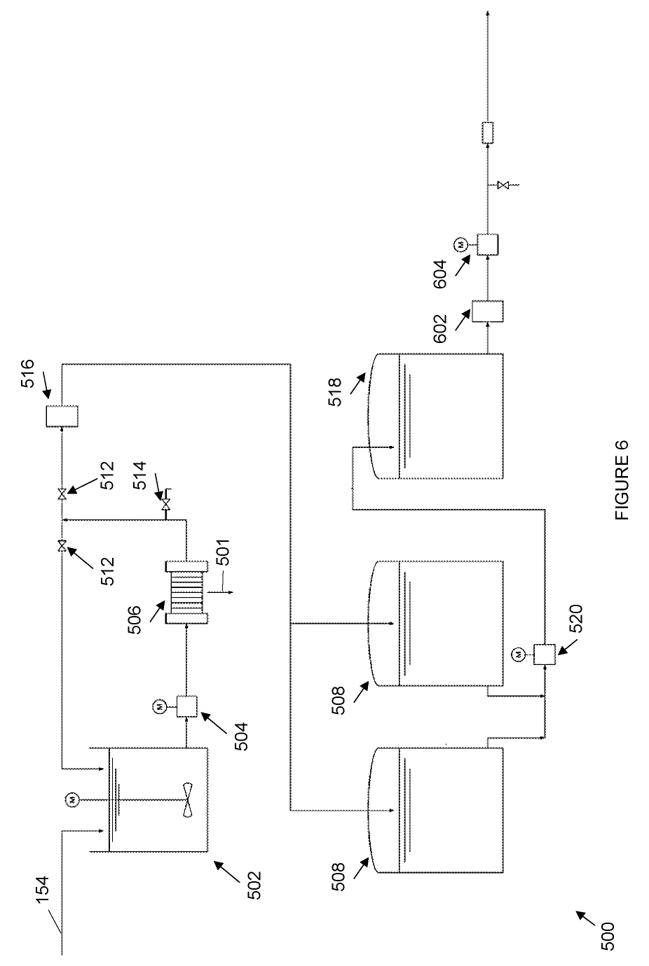

Referring to FIG. 6, the brine solution (154) containing fine dross particles is fed from the washing section (200) to a filtration section (500). Here, the brine solution is pumped to a brine holding tank which stores the brine and has a capacity of 12 m³. The holding tank is equipped with a centrally mounted, hydraulically driven agitator.

A filter feed pump (504) feeds the brine solution from the brine holding tank (502) through a filter press (506). The filtrate may be recycled back to the brine holding tank (508) or transferred to a brine storage tank at the dryer section (600). Diversion valves (512) are used to alternate between the possible routes of the filtered brine solution.

The filter press (506) is, in this embodiment, a plate-and-frame unit which holds multiple recessed plates. The plates are covered with individual filter cloths clamped together using a hydraulic cylinder which forms chambers between the plates. The brine solution is pumped into the filter press and passes into the chambers. The liquid passes through the cloth and returns to the brine holding tank while the solids (510) are captured by the filter cloth and build up in the chambers. Initially, the filtered brine may be slightly cloudy due to extremely fine dross particles managing to pass through the filter cloth. During this period all the filtered brine may be recycled back into the holding tank. As filtration progresses, dross builds up on the filter cloth surfaces and provides an additional filtration layer which improves the brine clarity. Samples (514) of the filtered brine may be taken periodically, for the clarity to be inspected. When the clarity is in an acceptable range, the operator diverts the filtered brine solution to storage at the dryer section (600).

As the filtration cycle continues, solids build up in the filter press (506) chambers. During the solids build-up, the discharge pressure of the pump (504) increases. When the operator determines that the chambers are full of dross, the pump (504) is stopped. The filter press (506) is then opened, and each chamber is emptied of dross individually and the cloths are cleaned as required. The solids are removed and transferred to storage. The plates are re-assembled, the filter press is closed, and a new cycle may begin.

A number of additional filters may be utilised in addition to the filter press. A secondary filter (516) is a small filter installed in the filtered brine supply line to the storage tanks at the dryer section (600). The purpose of the secondary filter (516) is to capture very small quantities of dross which have managed to get through the filter press (506). It is a polishing filter and should not be exposed to large quantities of solids. It is thus important that 99% or more of the filtration is carried out by the filter press (506).

In the present embodiment there are two brine storage tanks (508). Each storage tank (508) has a capacity of 20 m³. The storage tanks (508) provide intermediate storage between filtration section (500) and the drying section (600). Stored filtered brine solution is transferred to the dryer feed tank (518) by the brine transfer pump (520), as required. The brine transfer pump (520) transfers brine from either of the storage tanks (508) into the dryer section (600) feed tank (518), as required.

The filtration of the fine dross particles is performed to maximise the purity of the dried mixed salt produced after drying and to prevent discoloration of the generally white mixed salt. The flowrate of brine solution to be filtered (routed from the washing section (200)) may be expected to be between 1500 l/h and 2000 l/h.

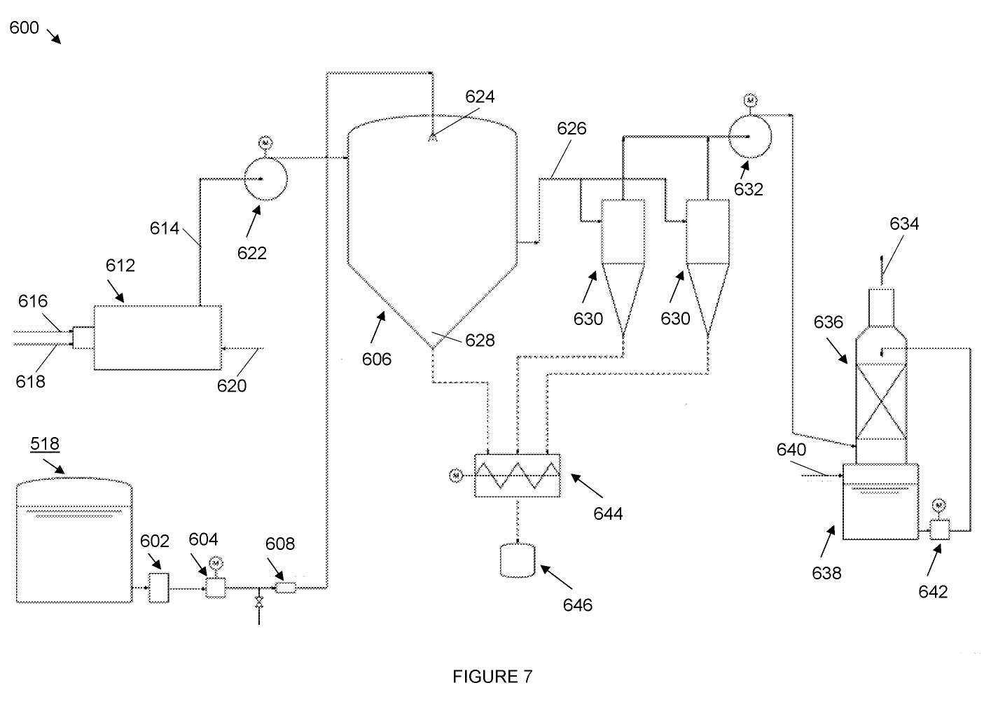

Referring to FIG. 7, the filtered brine solution is fed from the filtration section (500) to the dryer section (600). The filtered brine is pumped to a dryer feed tank (518) having a capacity of 20 m³. The filtered brine solution is routed from the dryer feed tank and passes through a guard strainer (602) and into the dryer feed pump (604). The guard strainer (602) is situated between the dryer feed tank (518) and the dryer feed pump (604) and provides protection to the dryer feed pump (604) by preventing any large (equal or larger than 500 μm) solids entering the dryer feed pump (604). The guard strainer (602) is, in this embodiment, a basket-type strainer fitted with a 500 μm stainless steel mesh.

The dryer feed pump (604) pumps the filtered brine solution to the dryer (606) and is a stainless steel, multi-stage centrifugal pump capable of producing a pressure of up to 16 bar. It is driven by an electric motor of 4 kW equipped with a VSD in order to adjust the flowrate.

A flowmeter (608) is installed in the dryer feed pump discharge line to the dryer (606) and measures instantaneous flow and has a totalising function. In the present embodiment, the flowmeter is a magnetic flowmeter.

In the present embodiment, the dryer section (600) has a burner and combustion chamber (612) to provide hot gas (614) required to dry the brine solution in a spray dryer (606). The burner combusts light fuel oil (616) in air and is connected to the large combustion chamber. Dilution air (620) may be fed into the combustion chamber to regulate the gas temperature. The gas (614) temperature leaving the combustion chamber is preferably controlled between 300° C. and 350° C. The combustion chamber is further refractory lined.

A forced draught (FD) fan (622) extracts the hot gases (614) from the combustion chamber (612) and blows tangentially into the spray dryer chamber (606). The FD fan (622) is driven by an electric motor of 75 kW and is equipped with a VSD in order to adjust the gas flowrate.

The spray dryer (606) is a large cylindrical chamber with a conical base where the liquid content of the brine evaporates, and dry powdered salt is formed. The brine solution is pumped at high pressure into a single, central spray nozzle (624) which produces a fine spray. Hot gas from the FD fan (622) enters the dryer chamber tangentially and mixes with the spray of the brine solution. The contact time between the hot gas and brine solution is long enough to ensure complete evaporation of the liquid and resulting in salt crystallising out of the solution, typically as a powder. The salt the results typically consists of a mixture of sodium chloride and potassium chloride and represents the salts used in the flux for the secondary smelting process.

The evaporation of the liquid cools the hot gas and the target temperature for the gas leaving (626) the chamber is around 112° C. and 115° C. At this temperature the mixed salt powder has a moisture content of around less than 0.5%. At lower temperatures, the moisture content will be higher than required. At higher temperatures the drying process will become less efficient. The coarser salt particles fall into the bottom cone section (628) of the dryer where they are collected. The finer salt particles remain entrained in the gas stream and leave the chamber through side ducting at the bottom of the cylindrical section.

Cyclone separators (630), typically referred to as cyclones, are used to capture the majority of the fine salt entrained in the gases (626) leaving the dryer chamber. In the current embodiment, two cyclones (630) are utilised in parallel. Gas (626) and entrained fine salt enter the cyclone tangentially, and the coarser particles are separated by centrifugal forces and collected at the base of the cyclone. The finer salt remains entrained in the gas stream and passes out of the top of the cyclone.

An induced draught (ID) fan (632) extracts the gases from the spray dryer (606) chamber through the cyclones (630) and the remainder of the process and then discharges the gases to atmosphere (634). The ID fan (632) is driven by an electric motor of 75 kW and is equipped with a VSD in order to adjust the gas flowrate.

A dust scrubber (636) is also utilised in the drying section (600). In the present embodiment, the process includes two dust scrubbers (636); where one is in use, and another is on standby. The dust scrubbers (636) capture the finer salt particles that managed to pass through the cyclones (630). The dust scrubber (636) is a cylindrical column of 2 m in diameter and 8 m in height mounted on top of a liquid reservoir (638). The gas along with the finer fine salt enters the bottom of the scrubber and passes upwards. A recirculating stream of liquid is pumped from the scrubber reservoir into the top of the scrubber and flows downwards. As the liquid flows downwards, it contacts the upwards flowing gas and captures the finer salt particles and returns them to the liquid reservoir (638). The gas (634) leaving the dust scrubber is substantially solids-free. The gas temperature entering the scrubber is between 90° C. and 100° C. The hot gas heats the recirculation liquid and causes some evaporation. The cooled gas leaves the dust scrubber at between 50° C. and 60° C. Make-up liquid (640) may be added to the dust scrubber reservoir as required to replace evaporation losses and maintain a constant liquid level.

The finer salt dissolves in the liquid over time and the liquid’s SG will slowly increase in the liquid reservoir (638). When the SG reaches a value of between 1.15 and 1.20, preferably 1.18, the liquid (with dissolved salt particles and other insoluble particles) is pumped to the filtration section (500) of the process to first remove any insoluble particles before being routed to the dryer (606). Recirculation pumps (642) recirculate water from the liquid reservoir (638) to the top of the dust scrubber (636) column and back into the liquid reservoir (638). The recirculation pumps (642) are centrifugal pumps and in the present embodiment, two recirculation pumps (642) are installed in parallel. The recirculation pumps are driven by electric motors of 1.1 kW.

A ribbon blender (644) is used to blend the coarser salt from the base of the spray tower (606) after drying with finer salt from the cyclones (630). A mixed salt with a consistent bulk density is produced in this manner. The ribbon blender (644) is driven by electric motors of 11 kW and the product is collected in bulk bags (646). This salt mixture can be re-used for further smelting, particularly as it occurs in the same ratio as used in the previous smelting process which resulted in the aluminium dross.

The process effectively enables what is considered to be toxic landfill, aluminium smelter dross, to be turned into a range of useful products with no wastage and no harmful effluent. The process results in the production of hydrolysed slag which is suitable for use in the cement industry, an ammonia sulphate solution which can be used as liquid fertiliser and mixed salts which can be re-used in a secondary aluminium smelting process. The only water used in the process is returned to the atmosphere as water vapour after the drying process, and the sulphuric acid is consumed in the production of the ammonium sulphate. A highly cost effective and environmentally friendly process is thus provided.

It will be appreciated that many other embodiments of a process exist which fall within the scope of the invention, particularly regarding process conditions and the equipment used.

Referring to the washing section (200), targeting a brine solution SG of preferably 1.18 may be dependent on the process and further optimisation. As the process operates and efficiencies decrease, the target SG of the brine solution may be adjusted in order to maintain optimum operational capability. In the present embodiment, water is used as the solvent but any other suitable liquid capable of dissolving the salts in the particulate dross may be used. In the present embodiment, process control is manual, but the process control can also be automated.

Also, the brine solution, or part thereof, may also be recycled into the drum washer (104) if required.

Referring to the hydrolysis section (300), three hydrolysers are utilised. Depending on the process and capacity of the process, a different number and type of hydrolyser may be utilised and these may be configured to operate on a continuous or semi-continuous basis. Another embodiment for hydrolyzing may include a hydro tunnel. In this embodiment the wetted dross (144) which exits spiral washer 3 (110) is fed into bulk bags which are out into the hydro tunnel suspended on beam trolleys. The intention is for the bags to displace one another and be fully reacted by the time the bulk bags reach the end of the tunnel. The ammonia gas generated while the bags are in the hydro tunnel is extracted via ducting connected to the ammonia scrubber section (400).

Referring to the filtration section (500), any method of separating the finer dross particles from the brine solution may be utilised. In the present embodiment a filter press (506) is used with a secondary filter (516) utilised as a polishing filter. It will be appreciated that any number of filters or types of filters may be utilised for this purpose.

Referring to the dryer section (600), spray drying is used to evaporate the liquid from the brine solution. It should be appreciated that another method may be used to remove the liquid from the brine solution. This may include various forms of crystallisation with the final method decided by the capital cost versus the operating cost and efficiency.

Throughout the description, references to dimensions and characteristics of equipment are by way of example and different dimensions, characteristics and types of equipment will be apparent to one skilled in the art.

Furthermore, energy ratings, energy requirements or process parameters are given by way of example only and these may clearly be tailored to specific requirements.

The foregoing description has been presented for the purpose of illustration; it is not intended to be exhaustive or to limit the technology to the precise forms disclosed. Persons skilled in the relevant art will appreciate that many modifications and variations are possible in light of the above disclosure.

The language used in the specification has been principally selected for readability and instructional purposes, and it may not have been selected to delineate or circumscribe the inventive subject matter. It is therefore intended that the scope of the present disclosure be limited not by this detailed description, but rather by any claims that issue on an application based hereon. Accordingly, the present disclosure is intended to be illustrative, but not limiting, of the scope of any accompanying claims.

Finally, throughout the specification and any accompanying claims, unless the context requires otherwise, the word ‘comprise’ or variations such as ‘comprises’ or ‘comprising’ will be understood to imply the inclusion of a stated integer or group of integers but not the exclusion of any other integer or group of integers.

1. A process for the removal of salts from an aluminium dross which comprises the steps of:
leaching particulate dross with a solvent to produce a brine solution and wetted dross;
separating the wetted dross from the brine solution;
hydrolysing the wetted dross to produce gas and a hydrolysed dross;
reacting the gas with an acid, producing a salt solution; and
removing liquid from the brine solution to produce a salt product.

2. The process as claimed in claim 1, which comprises removing residual brine from the wetted dross before hydrolysing the wetted dross.

3. The process as claimed in claim 2, which comprises removing residual brine from the wetted dross by mixing water with the wetted dross in one or more separators to produce a leaching solution.

4. The process as claimed in claim 3, which comprises leaching the particulate dross with the leaching solution.

5. The process as claimed in claim 1, which comprises removing fine dross particles from the brine solution before removing the liquid.

6. The process as claimed in claim 1, wherein the wetted dross is separated from the brine solution using one or more spiral washers.

7. The process as claimed in claim 1, wherein the gas is an ammonia gas.

8. The process as claimed in claim 1, wherein the acid is sulphuric acid.

9. The process as claimed in claim 1, wherein the salt solution is an ammonium sulphate solution.

10. The process as claimed in claim 1, which comprises separating fine dross particles from the brine solution in one or more filtration assemblies.

11. The process as claimed in claim 1, which comprises removing liquid from the brine solution by spray drying.

12. The process as claimed in claim 1, which comprises removing liquid from the brine solution by crystallisation.

13. The process as claimed in claim 1, which comprises maintaining the specific gravity of the brine solution at between 1.15 and 1.20.

14. The process as claimed in claim 13, which comprises maintaining the specific gravity of the brine solution at 1.18.

15. The process as claimed in claim 1, wherein the salt product is a mixture of sodium chloride and potassium chloride.
